(19) United States
(12) Patent Application Publication
(10) Pub. No.: US 2012/0088202 A1
(43) Pub. Date: Apr. 12, 2012

(54) HEATING DEVICE FOR SOLDERING SYSTEM

(76) Inventor: Lambertus Petrus Christinus Willemen, Dorst (NL)

(21) Appl. No.: 13/267,102

(22) Filed: Oct. 6, 2011

(30) Foreign Application Priority Data
Oct. 11, 2010 (DE) 20 2010 014 074.9

(51) Int. Cl. F27B 9/10; F24H 3/02

(52) U.S. Cl. 432/221; 392/360; 432/152

(57) ABSTRACT

A heating device for a soldering system. One embodiment of the heating device has at least one heating nozzle equipped with at least two tubular outlet channels. At least one outlet channel of the heating nozzle is arranged at an angle opposite another outlet channel of the heating nozzle. One embodiment of a selective soldering system is also provided. The selective soldering system comprises a heating device and a selective soldering device which is connected downstream from the heating device. The heating device is equipped with at least one heating nozzle in order to guide the heating current in the direction of a flat side of each board to be soldered. At least one heating nozzle is equipped with at least two tubular outlet channels, and at least one outlet channel of each heating nozzle is arranged at an angle opposite another outlet channel of each heating nozzle.

### RELATED APPLICATIONS

This application is a new non-provisional application claiming priority to German Utility Model No. 20 2010 014 074.9, Filing Date: Oct. 11, 2010, entitled “Heating Device for a Soldering Arrangement”, the disclosure of which is incorporated herein by reference.

### TECHNICAL FIELD

The invention relates to a heating device for a soldering system, as well as to a selective soldering system.

### BACKGROUND

Various methods have been established in order to realize automated soldering of electronic boards. These methods include the reflow soldering method and the wave soldering method. A variant of the wave soldering method is the selective soldering method.

During selective soldering, liquid solder is pumped with a pump into a nozzle which is located in a solder bath. A small solder wave is created during the pumping of the solder into the nozzle which flows off into the solder bath.

The board to be soldered is guided through the solder wave depending on the layout of the board. The handling of the board is usually automated with a corresponding handling system. Almost any soldering task can thus be realized with a small equipment cost.

It is also possible to imagine a system in which several selective solder waves are produced in a solder bath. It is then sufficient when the board is set up in a predetermined manner in the arrangement of selective solder waves. The guiding of the board as explained above is then no longer required. An example of a selective solder system is disclosed in DE 10 2007 002 777 A1.

A selective soldering system usually consists of a flux device, a preheating device and finally also a selective soldering station. A fluxing agent is added in the flux device in the locations of the board to be soldered. The preheating device is used to provide an appropriate preheating of the board in order to activate and secure the fluxing agent so that the board will not be exposed to a temperature shock during the subsequent soldering.

### SUMMARY

The construction of the preheating device plays a decisive role for the quality of solder which can be achieved in the soldering station. It is important in this case to apply heating that is as homogenous as possible to the flat side of boards. At the same time, only a limited time period is available for the heating.

The known heating device (DE 44 01 790 C1) on which the invention is based discloses a hot air heating device which is equipped with several oblong nozzles. A disadvantage of this known heating device is the fact that in spite of the directed production of a turbulent current, homogenous heating of the electronic board cannot be guaranteed. The reason for this is the fact that the hot current of the individual nozzles results in each case in heating which has a substantially linear form.

The objective of the present invention is to design and further improve the known heating device in such a way that homogenous heating of an electronic board can be achieved above its flat side.

The above mentioned problem is solved with a heating device having at least one heating nozzle equipped with at least two tubular outlet channels, at least one outlet channel of the heating nozzle being arranged at an angle opposite another outlet channel of the heating nozzle.

It is in this context important to acknowledge that it is possible to achieve a particularly homogeneous heating when the heating nozzle is equipped with an outlet channel which is formed as a small tube, wherein at least one outlet channel of the heating nozzle is arranged at an angle for the formation of the outgoing heating current opposite another outlet channel.

The term “formation” in this case indicates the defined influence of the outgoing heating current, namely with respect to its spatial propagation on the one hand, and on the other hand with respect to the conduct of the current, in particular with respect to the turbulence level and the laminarity.

It would be possible to show in experiments that the heating current can be formed with an arrangement of outlet channels which are arranged at an angle to each other in such a way that substantially homogenous heating of the board is achieved. Focusing of the heating current which is discharged from the nozzle can be avoided in a simple manner because this would lead to an undesirable selective heating of the board.

In particular, a predetermined level of turbulence can be easily adjusted in the area of the board where soldering is to be performed with the proposed soldering system, which has proven to be advantageous for the homogeneous heating of the board.

The advantage according to the proposal can be fully utilized with a design which provides for multiple heating nozzles arranged next to each other. As long as the heating currents of adjacent nozzles are superimposed at least slightly in the area of the board, even large surfaces can be heated homogeneously.

Claims 4 through 9 relate to preferred embodiments of the outlet channel. Particularly advantageous is in this case the configuration in which the heating nozzle is equipped with a central outlet channel which is surrounded by a plurality of peripheral outlet channels arranged opposite and at an angle to the central channel. The combination of a central heating channels with several peripheral heating channels leads to a widening of the heating current which is discharged from the heating nozzle, without a “disruption” of the central area of the heating current. The configuration is in particular suitable for combinations of several heating nozzles which are arranged next to each other.

According to another teaching, a selective soldering system for selective soldering of electronic boards is provided, comprising: a heating device and a selective soldering device which is connected downstream from the heating device, the heating device being provided for preheating of at least one flat side of each board to be soldered by means of a gaseous heating current, and the heating device being equipped with at least one heating nozzle in order to guide the heating current in the direction of the flat side of each board, at least one heating nozzle being equipped with at least two tubular outlet channels, and at least one outlet channel of each heating nozzle being arranged at an angle opposite another outlet channel of each heating nozzle for the formation of the heating current being discharged.

The selective soldering system is equipped with a heating device and a selective soldering device which is connected downstream from the heating device, wherein the heating device is used for the preheating of at least one flat side of the board to be soldered by means of a gaseous heating current.

The important fact according to this teaching is that the heating device is the heating device according to the proposal above.

All the embodiments of the proposed heating device can be referenced in this manner.

### BRIEF DESCRIPTION OF THE DRAWINGS

The invention will now be explained in more detail with reference to attached figures which refer only to embodiments thereof. The figures show the following:

FIG. 1 a selective soldering system according to the proposal having a heating device shown in a purely schematic illustration,

FIG. 2 the heating device according to FIG. 1 shown in a lateral profile view,

FIG. 3 the arrangement of the heating nozzles of the heating device according to FIG. 1 shown in a perspective illustration and

FIG. 4 a heating nozzle of the arrangement a) illustrated in FIG. 3 shown in a top view and b) in a lateral profile view.

### DETAILED DESCRIPTION

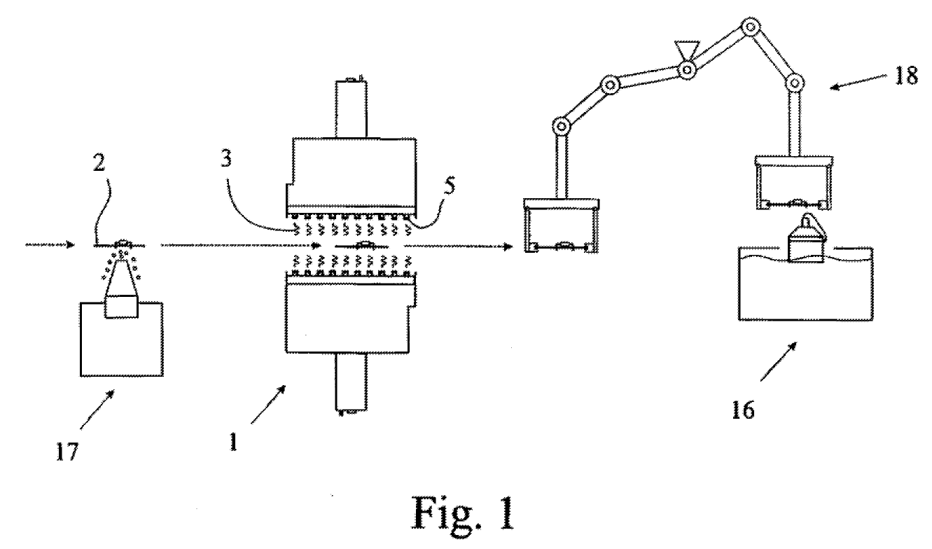

The soldering system indicated in FIG. 1 relates to a selective soldering system in which the proposed heating device 1 can be integrated in a particularly advantageous manner. However, it is also possible to apply the concept of the application of the heating device according to the proposal in wave soldering systems using any type of equipment, as well as in reflow soldering systems.

The soldering system is used for soldering of electronic boards, as is essentially known from prior art. The heating device 1 is used to heat, in this case to preheat, both flat sides of the boards, in this case of the board 2 to be soldered. It is essentially also possible that only the flat side of the board is heated on which soldering is to be performed.

The heating device 1 produces for the heating of the plate 2 a gaseous heating current 3 which is directed towards the relevant flat side of the board. In order to generate the heating current 3, the heating device 1 is usually provided with a fan 4 or the like.

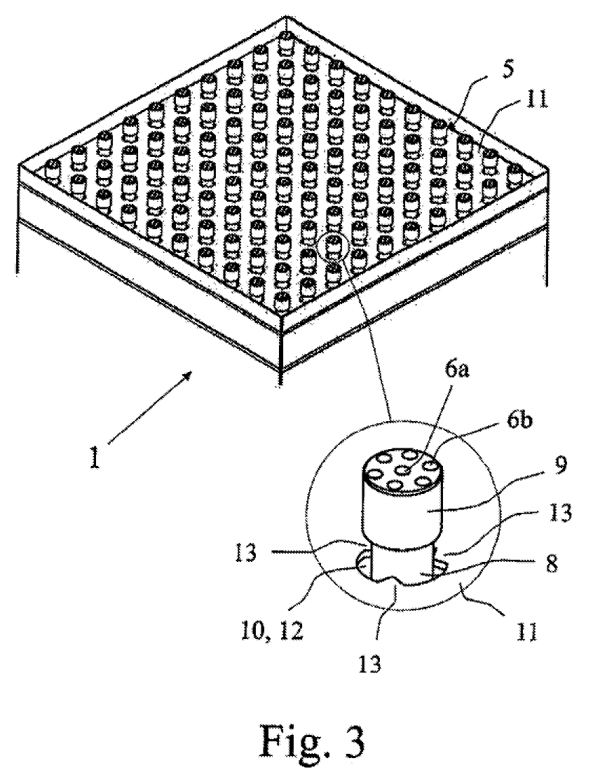

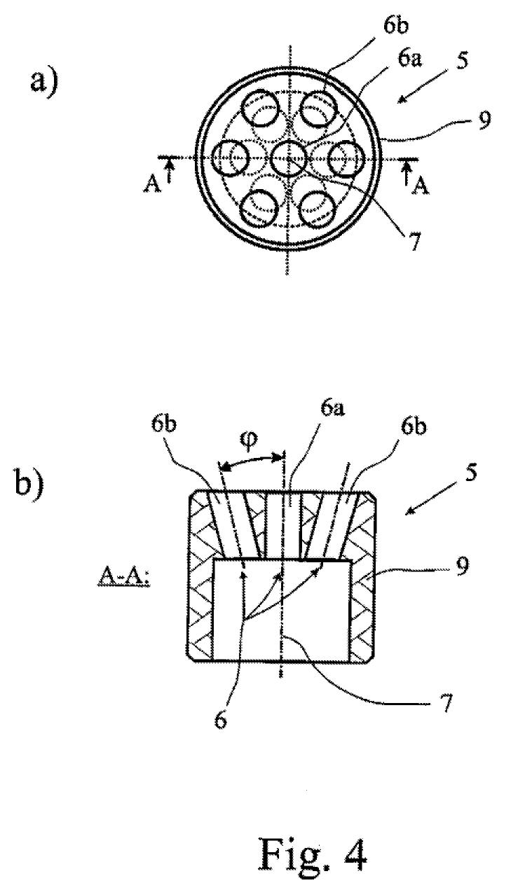

The heating device 1 is equipped here and preferably with several heating nozzles 5 for discharging of the heating current 3 in the direction of the flat side of each board. The design of individual heating nozzles 5 can be seen best by looking both at FIG. 3 and FIG. 4.

Of particular importance is in this case the fact that each heating nozzle 5 is equipped with at least two outlet channels 6, and that for the formation of the heating current being discharged, at least one outlet channel 6 of each heating nozzle 5 is arranged at an angle opposite another outlet channel 6 of each heating nozzle 5. This can be seen in the illustration which is indicated in FIG. 4b).

In the configuration which is preferred so far and which is indicated in FIG. 3, multiple heating nozzles 5 are provided arranged next to each other. It is advantageous when the heating nozzles 5 are arranged in a two dimensional array, wherein a substantially parallel alignment of the heating nozzles to each other is preferred.

The distance between the heating nozzles 5 is in this case of particular importance. It is preferred when the heating nozzles 5 are arranged in such way that the heating currents 3 are at least slightly mutually superimposed in the area of the board 2. Boards having a large surface area can thus be heated in a homogenous manner.

The emphasis is placed in the present configuration on the heating nozzle 5 itself. Although only one heating nozzle 5 is mentioned in the description below, this description should not be understood as limiting. All embodiments of a single heating nozzle 5 are also applicable to a plurality of heating nozzles 5 mentioned above.

As one can see from FIG. 4a), the heating nozzle 5 is equipped with a central channel 6a, which is surrounded by three, here and preferably by six peripheral outlet channels 6b. It is also conceivable that several central outlet channels 6a can be provided which are preferable arranged parallel to each other. The term “peripheral” means that the corresponding outlet channels 6b surround at least one central outlet channel 6a and/or also a central axis which will be described later.

In a particularly preferred embodiment, the heating nozzle 5 is provided with a number of peripheral outlet channels 6b which are arranged at an angle opposite the central axis 7, in particular so that they are equally distributed. In the embodiment shown in the figure, the peripheral outlet channels 6b are arranged symmetrically relative to the central axis 7, which in particular simplifies the design of the outlet channels 6 for the formation of the heating current 3 described above. The outlet channels 6 are in particular arranged in such a way that every two outlet channels 6 are positioned on a straight line which runs through the central axis 7, specifically at right angle to the central axis 7.

In the embodiment illustrated in the figure, the inclination angle φ of all peripheral outlet channels 6b to the central axis 7 is substantially identical. In principle it is also possible when a different angle of inclination is set for the peripheral outlet channels 6b.

In order to make it possible to achieve the widening of the heating current 3 mentioned above, the peripheral outlet channels 6b are diverging when seen from the perspective along the current direction. This is shown in FIG. 4b, wherein the direction of the current in this illustration is from the bottom to the top.

A synopsis of FIGS. 4a) and 4b) shows that the peripheral outlet channels 6b are arranged in profile in a circle perpendicularly to the central axis 7. It is also conceivable when the peripheral outlet channels 6b are arranged on a rectangle or on a straight line.

Optimal results for homogenous heating were shown when the central outlet channel 6a was aligned concentrically to the central axis 7 as shown in the figure. As long as several outlet channels 6a are present, the central outlet channels 6a are aligned parallel to the central axle 7.

The characteristics of the heating nozzle 5 can be adjusted with the design in a wide range. It is important to ensure in this connection that in particular the distances between the heating nozzles, the distance from the heating nozzle 5 to the respective flat sides of the board, and the angle of inclination of the peripheral outlet channels 6b are mutually adjusted.

The adjustment mentioned above is preferably realized so that as explained above, the heating current 3 of the adjacent heating nozzles 5 is at least slightly superimposed in the area of the board 2.

It is preferred when the three parameters mentioned above are mutually determined so that the imaginary longitudinal axes of the peripheral outlet channels 6b facing each other of the adjacent heating nozzles 5 come very close to each other with a suitable tilted position of the heating nozzles 5 (relative to the central axis 7) in the vicinity of the flat side of the boards, they can even meet or intersect. The central axes 7 of the heating nozzles 5 are preferably aligned parallel to each other.

The slight superimposition of the heating currents 3 of the adjacent heating nozzles 3 mentioned above can thus be easily achieved, which can be in each case further fine-tuned in tests.

The central axes 7 which are associated with the heating nozzles 5 are preferably aligned parallel to each other as mentioned above. However, it is also conceivable that the central axes could be arranged at an angle to each other depending on the position of each heating nozzle 5.

The heating nozzles 5 can be all set to the same tilted position relative to each central axis 7, so that all the heating nozzles 5 are oriented in the same manner seen from the plate 2 to be soldered with the opening pattern which is formed by the outlet channel 6. It is also conceivable when for example a random distribution of the tilted positions of the heating nozzles 5 is created relative to each central axis 7.

In the embodiment which was illustrated and preferred so far, the distance from the heating nozzles 5 to each flat side of the board is in the range from 60 mm to 80 mm. The distance between respective heating nozzles 5 is in the range from 30 mm to 50 mm.

It is preferred when the inclination angle φ of the peripheral outlet channels 6b to each central axis 7 is in the range from 10° to 20°, preferably 15°.

The outlet channels 6 preferably have a circular profile and they are provided with a diameter between 2 and 4 mm, preferably 3 mm. In principle, the outlet channels 6 can be also provided with another profile form.

The outlet channels 6 are provided at least partially with a straight design. However, it is in principle also conceivable that the outlet channels 6 could be also created with a curved or buckled design.

The heating nozzle 5 is designed here and preferably so that it is fully rotationally symmetrical relative to the central axis 7. All the outlet channels 6 are thus accommodated with a diameter about the central axis 7 of less than 15 mm, in particular less than 13 mm.

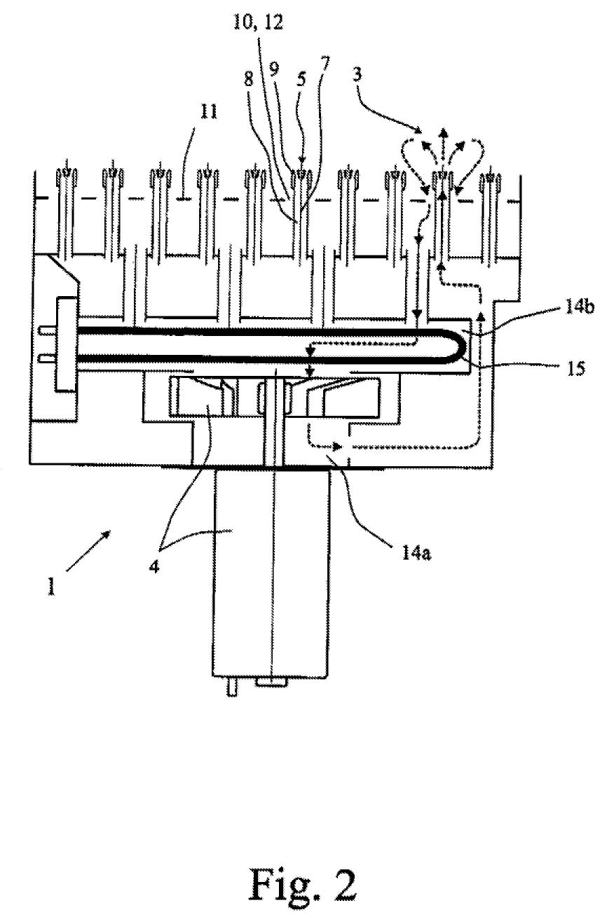

FIG. 2 shows the integration of the upper heating nozzles 5 in the heating device 2. As shown in FIG. 2, the heating nozzle 5 is equipped with a tubular section 8 which is connected to a nozzle head 9 accommodating the outlet channels 6. In the simplest case, the nozzle head 9 is designed in particular as a type of a cap and it is pushed onto the tubular section 8. According to another variant, the nozzle head 9 is inserted in the tubular section 8.

As one can further also see from FIG. 2, the tubular section 8 passes through the through opening 10, which allows its passage in a wall 11 of the heating device, wherein this through opening 10 is designed so that a reflux opening 12 is created between the wall 11 and the tubular section 8 which is used for the reflux of the heating current 3.

Of interest is in the present embodiment the construction of the through opening 10. Specifically, the through opening 10 is not designed as a circular opening, but instead it is provided with centering elements 13 which have a substantially radial orientation, in this case with centering tips 13. This ensures on the one hand the centering of the heating nozzle 5, and on the other hand also the reflux of the heating current 3.

It was further also proven in experiments that the arrangement of the opening 12 for the reflow of the heating current 3 directly on the tubular section 8 of the heating nozzle 5 leads to an optimal formation of the heating current 3.

It is essential for the resulting heating current 3 that the heating nozzles 5 are protruding over the wall 11 which is provided with the through openings 10. An influence is exerted on the resulting heating current 3 in particular by the distance, wherein the distance is in this case between 70 and 120 mm, so that the heating nozzles 5 would be protruding relative to the wall 11 which is provided with the through openings 10.

The path of the heating current 3 is indicated in FIG. 2 by arrows. The current is discharged on the excess pressure side 14a of the fan 4 and it is conducted by the tubular section 8 and the nozzle head 9 outside in the direction of each flat side of the board. After that, the heating current 3 flows through one of the reflow openings 12 on a heating element 15 up to the reduced pressure side 14b of the fan 4. The heated air will then reach again the excess pressure side 14 of the fan 4 and the heating nozzle 5 in the manner described above.

In a particularly simple embodiment, all the heating nozzles 5 are impacted by the heating fan 4. However, in principle it can be advantageous when the heating nozzles 5 are impacted by different heating currents 3 depending on their position. This is applicable for example to heating nozzles 5 which are arranged at the edges of the heating device 1, which can be optionally also impacted by external air flowing in from outside.

It is particularly advantageous from the technical and manufacturing viewpoint when all the heating nozzles 5 are designed in an identical manner. However, it is in principle also possible to combine together heating nozzles 5 which have a different design in order to achieve an optimal heating behavior.

According to yet another teaching which also acquires an independent meaning, a selective soldering system is claimed as such for selective soldering of electronic boards 2. A selective soldering system according to the proposal is illustrated in FIG. 1.

The selective soldering system according to the proposal is provided with a heating device 1 and with a selective soldering device 16 which is connected downstream from the heating device 1. A flux device 17 is connected in the customary manner upstream from the heating device 1. The heating device 1 serves for preheating of at least one flat side of a board, in this case of both flat sides of a board, namely of each flat side of the board 2 to be soldered, by means of a gaseous heating current 3. The heating device 1 corresponds to the heating device 1 according to the proposal above, so that the entire range of the embodiments described above can be referred to.

Of particular interest with respect to the proposed teaching is the operation of the selective soldering system illustrated in FIG. 1.

The board 2 which is to be soldered first passes through the flux device 17, and then it passes through the heating device 1 on a conveyer belt or the like. Selective soldering is carried out with a multi-axial handling device 18 which picks up the board 2 and supplies it to a selective soldering device 16. After the end of the soldering process, the handling device 18 puts down the board 2 and picks up a board which is exiting from the heating device 1 in order to supply the next board 2 to the selective soldering device 16.

It is clear from the description above that the selective soldering process is a discontinuous process which is interrupted at regular intervals. This means that the boards to be soldered must be left for different waiting time periods in the heating 1 before they can be picked up by the handling device 18.

In the context of the discontinuous operation described above it is also clear that the homogenous heating of the boards 2 is of particular importance. The potentially longer waiting time periods in the heating device 1 lead with unequal heating to so called undesired heat concentrations which are also referred to as hot spots. Such hot spots can be prevented with the heating device 1 according to the proposal, even under complicated marginal conditions in a selective soldering device.

1. A heating device for a soldering system for soldering of electronic boards, the heating device heating at least one flat side of a board which is to be soldered by means of a gaseous heating current, the heating device being equipped with at least one heating nozzle in order to guide the heating current in the direction of the flat side of each board,
said at least one heating nozzle being equipped with at least two tubular outlet channels, and at least one outlet channel of the heating nozzle being arranged at an angle opposite another outlet channel of the heating nozzle for the formation of the exiting heating current.

2. The heating device according to claim 1, wherein multiple heating nozzles are provided arranged next to each other, such that the heating nozzles are arranged in a two-dimensional array, wherein the heating nozzles are substantially parallel to each other.

3. The heating device according to claim 2, wherein the multiple heating nozzles are arranged in such a way that the heating currents of adjacent heating nozzles overlap on said at least one flat side of the board.

4. The heating device of claim 1, wherein said at least one heating nozzle is equipped with at least one central outlet channel, which is surrounded by at least three peripheral outlet channels.

5. The heating device according to claim 4, wherein said at least one heating nozzle is equipped with peripheral outlet channels, which are equally distributed about the central axis.

6. The heating device according to claim 5, characterized in that wherein the peripheral outlet channels have angles of inclination with respect to the central axis which are substantially identical.

7. The heating device according to claim 6, wherein the peripheral outlet channels diverge when viewed along said central axis.

8. The heating device according to claim 7, wherein the peripheral outlet channels are arranged such that they form a pattern consisting of a circle, a rectangle, or a straight line, said pattern being perpendicular to the central axis.

9. The heating device according to claim 4, wherein at least one central outlet channel is concentric with the central axis.

10. The heating device according to claim 1, wherein at least one heating nozzle is equipped with a tubular section which is connected to a nozzle head accommodating the outlet channels, so that the nozzle head is pushed onto the tubular section, or inserted in the tubular section.

11. The heating device according to claim 10, wherein the tubular section penetrates through a through opening created in a wall of the heating device, wherein this through opening is designed so that a reflow opening is provided between the wall and the tubular section which is used for reflow of heating current.

12. A selective soldering system for selective soldering of electronic boards comprising a heating device and a selective soldering device which is connected downstream from the heating device, the heating device being provided for preheating of at least one board flat side of each board to be soldered by means of a gaseous heating current, and the heating device being equipped with at least one heating nozzle in order to guide the heating current in the direction of the flat side of each board,
at least one heating nozzle being equipped with at least two tubular outlet channels, and at least one outlet channel of each heating nozzle being arranged at an angle opposite another outlet channel of each heating nozzle for the formation of the heating current being discharged.

13. The selective soldering system according to claim 12, wherein the heating device is designed for preheating of a board to be soldered.
